(19) United States
(12) Patent Application Publication
(10) Pub. No.: US 2009/0322869 A1
(43) Pub. Date: Dec. 31, 2009

(54) METHOD FOR OBSERVING CELLS, CHIP AND DEVICE

(76) Inventor: Xingyue Peng, Fujian (CN)

Correspondence Address: Dr. BANGER SHIA;Int''l Patent Office of Bang Shia, 102 Lindencrest Ct, Sugar Land, TX, 77479-5201, US

(21) Appl. No.: 12/374,830

(22) PCT Filed: Aug. 27, 2007
(86) PCT No.: PCT/CN2007/002571

§ 371 Date: Jan. 23, 2009

(30) Foreign Application Priority Data
Aug. 29, 2006 (CN) 200610037470.0

(51) Int. Cl. H04N 7/18; G06K 9/00

(52) U.S. Cl. 348/79; 382/133; 348/E07.085

(57) ABSTRACT

A method for observing cells, a chip and a device are provided. The method includes: (1) a camera obtaining dynamically the position of cell, the direction and speed of flow in the microchannel within the chip on stage through a microscope and transferring the data to a computer, (2) the computer collecting real-time data from the camera and analyzing it, calculating the relation between the position of cell and pressure needed in the assay, at the same time comparing the result obtained with the real-time pressure fed back by micro pressure devices and received by the computer, and inputting controlling commands to micro pressure devices; (3) based on the commands, micro pressure devices changing the pressure of two ends of microchannel in the chip to adjust the direction and speed of flow in the microchannels of chip so as to regulate the position of cell in the flow. Observing of cells can be completed quickly with accuracy according to the invention. The present invention can be applied in dynamic study for cell in scientific research, medical detection and teaching.

### BACKGROUND OF THE INVENTION

1. Field of the Invention

The present invention relates to a method of the observation for cells research, in particularly to a method of proceeding a dynamic research with respect to the observation of cells applied for scientific research and medical studies, to an experimental chip of using same, and to a necessitate device of using same.

2. Description of the Related Art

For the biological analysis and the medical researches, the cell development has become a critical technology as those cells are necessary for life. Such technology performing to separate the cells from the living body for executing the extraneous culture usually has obstructions because the existence of the microenvironment around the cells would be facilely out of control. For instance, the injection of liquid reagents into the cells substantially benefits the observation of the cells through a microscope but inevitably renders the cells floated out of the lens of the microscope unless some specific physical or chemical ways are used to constrain them. Thus, the supra interferences may cause detriments to the cell experiment or development, and the efficient development of the cell retention and culture would make an important contribution to the research and application of the life science.

Thence, a PCT patent application published no. WO/2006/007701, issued by Simon et al., conducts a microfluidic device and its relevant method of using same that mainly applies a microfluidic chip technology to carry out the selection, separation, retention, and the culture of the particle (i.e. single yeast cell) within the fluid channel of the chip, so as to incessantly observe and record biological parameters of the single cell while delivering and shifting the reagents. Base on the control to the microenvironment of the cell and the retention of the cell float on the microfluidic, such technology theoretically solves the aforementioned problems that disturb the cell culture and experiment by applying the microfluidic chip device, in which microchannels and a partial retention structure in curved contour arranged therein are defined attempt to receive the cell within the curved structure for the observation by adjusting the pressure and speed of the fluidic. However, the chip device dedicates neither to perform the visualizing control of the fluid channel nor to show the way how to automatically control the microfluidic of the cell experiment. Since the experiment usually spends for days or weeks and the auto requirement, the conventional application supported by the theory may not be well adapted for the practical experiments, thus requiring improvements.

### SUMMARY OF THE INVENTION

The object of the present invention is to provide a method for swiftly and accurately observing cells.

Another object of the present invention is to provide an experimental chip of observing cells for ensuring the stability of the cells.

A further object of the present invention is to provide a relevant device for executing the experiment on observing cells, which mainly applies a camera identifying dynamically the position, the direction, and speed of cells and serving as a data transferring to efficiently control the microfluidic in the microchannel within the chip.

The method for observing cells in accordance with the present invention comprises procedures of: (1) data attaining: a camera is arranged to dynamically capture the position, the flowing orientation and speed of cells in the microchannel within the chip on a stage through a microscope and to transfer the received data to a computer; (2) analyzing and comparing: the computer collects the real-time data from the camera and proceeds to analyze and calculate the relation between the position of cell and pressure complied with the demand of the assay, as well as to compare the result with the real-time pressure fed back from micro pressure devices to the computer, whereby the computer accordingly serves to input controlling commands to micro pressure devices; and (3) controlling and adjusting: according to afore commands, the micro pressure devices changes the pressure supplied to both ends of the microchannel in the chip to adjust the flowing direction and speed of fluid in the microchannel of the chip so as to regulate the position of cell in the fluid.

The present invention also includes a chip adapted for the method. The chip has a microchannel, an interface system for the chip to communicate with the outside, and a sealing. Wherein, the interface system is divided into an input of reagents or nutrient agar and a controlling interface; the microchannel defines a curved cell control unit for making the cell observation and culture and has both ends thereof discretely connected to the controlling interface, so as to attach a side hole on a side wall of the microchannel face to the opening of the cell control unit with the input of reagents or nutrient agar; the sealing covering the chip obturates the channel of the chip for permitting the controlling interface to connect with micro pressure devices and further to adjust the pressure within the microchannel. Both the microchannel and the cell control unit have respective micropits where microballs can place to conduct the flowing speed and direction of the fluid at specific fluidic port, thereby performing the visualizing control of the fluid channel.

The microchannel and the cell control unit arrange a set of pits to become a pit array. The microballs in the pit would depict the flowing speed and directions of the fluid distributed among the fluidic ports. The pit array would directly show the fluid channel at the specific moment, and the real-time result from the instant fluid observation would assist the controlling system to have an accurate execution.

The interface system includes an input of reagents or nutrient agar; wherein, the input can be adapted for an injection of common liquid that requires damping buffering or adapted for an injection of specific liquid that is merely applied to the reagents with small and fixed measurement.

The interface system also includes a controlling interface that connects to two ends of the cell control unit through a damping microchannel. The controlling interface attaches with different positions within the microchannel in order to adapt kinds of cells relative to kinds of damping coefficients.

The chip is an integrity chip, the interface system includes an input of reagents or nutrient agar and a controlling interface; the microchannel has a cell control unit arranged thereon.

The microballs are magnetic balls. The balls are subjected to slightly vibrate under the stimuli of an exterior magnetic field, thereby avoiding the adhesions of the balls on inner walls of the pits to affect the indication.

The cell control unit includes a cell collecting unit attached with the inner wall thereof and serves to gather and save the cells. The cell collecting unit is formed of a gradual wider configuration, of which the narrow portion has one edge joined to the cell control unit; a blocking wall is thence disposed at the joint for interfering the cells flowed at a certain speed. Further, the wider portion thereof has one edge thereof attached to the interface system through the microchannel and also has a blocking wall serving to obstruct the cell flow; the wider portion can also guide the cultured cell within the cell collecting unit out through the interface if necessary.

The microballs in the pits for the fluid conduction or indication are magnetic balls. The balls are subjected to slightly vibrate under the stimuli of an exterior magnetic field, thereby avoiding the adhesions of the balls on inner walls of the pits to loss the conducting effect. The present invention can control the strength of the magnetic field in the fixed orientation to change the force exerted on the balls and hence to adjust sensitivity thereof.

The adhesion of the cells inside the microchannel affects the experiment controlling, and the adhesion would be subjected to acoustic wave. Therefore, an acoustic wave generator can be embedded into the chip to eliminate the occurrence of adhesion.

The present invention also includes a device adapted for the method. The device has a microscope, a camera, a computer, micro pressure devices, and a chip; wherein, the computer connects with the camera through system address buses; the camera is attached to the microscope; the chip is put on a stage; the micro pressure devices have their respective pressure outputs joined to the controlling interface of the chip by lines; the pressure output also connects to the computer by data lines so as to render the feedback of the instant pressure and accept the controlling commands from the computer.

The micro pressure device can adopt controlling ways regulated by air pressure and hydraulic pressure.

The micro pressure device is comprised of a pressure source and multiple air pressure controlling units; the pressure source connect with the air pressure controlling units through an air pressure passage; the pressure source mainly consists of a vacuum pump, a vacuum pond, a pressure exchanger, and a gauging apparatus; wherein, the vacuum pump connects with the vacuum pond, the gauging apparatus electrically engages with the vacuum pump and attaches to the vacuum pond through the pressure exchanger; the air pressure controlling unit includes a flow adjusting valve, an electromagnetic valve, a buffering container, a pressure exchanger, and a gauging mean; wherein, there are two sets of the flow adjusting valves in serial connection with the electromagnetic valves, and the two sets thereof are respectively engaged with an input passage and an output passage of the buffering container; the gauging mean is electrically connected with the electromagnetic valve disposed on the input and output passages of the buffering container and is joint to the buffering container through the pressure exchanger.

The micro pressure devices set by dynamic control could accept an air pressure source in great flow and adjust the air pressure by applying a series of cutoff valves arranged in serial or parallel connections. Alternatively, the devices could adopt a rapid reaction that fixes the serial pressure value to await the shift without exerting the incessant pressure controlling.

The micro pressure devices proceed to control hydraulic pressure by a displacing detector. The hydraulic pressure regulation has an adjustment more precise than that of the air pressure regulation but essentially has lower modulating ranges. Accordingly, it adopts to use the air pressure control accompanying the hydraulic pressure adjustment to attain the purpose of pressure controlling. Due to the possession of rapid reaction, the air pressure control serves to retrieve the cells to an anticipated location; further, the liquid adjustment takes advantages of executing the precise regulation to obviate the unbalance of the long-term cell culture, for instance the loss balance of the liquid level or of the damping. The air pressure control and the liquid adjustment can be a system embedded into the computer so as to attain an automatic controlling effect.

The microscope of the present device also includes a dual microscope having an optical path that gathers a coaxial and single light source; wherein, the dual microscope further comprises a reflecting microscope and an inverting microscope. The light of the light source is thrown to the chip for entering into an optical axis of the reflecting microscope through a reflecting mirror; further the reflected light returns to a CCD1 of the reflecting microscope that serves to observe the dynamic images for satisfying the dynamic control of the chip; the light through the chip is captured by a CCD2 of the inverting microscope that facilitates the biology observation.

From the above, the present invention mainly applies the microscope and the camera to initially capture the position and the flowing information of particles, to dynamically identify real-time data of the single- or multi-cell, and to deliver the data to the computer. The computer thence exerts to analyze and make the comparison between the data and the desired pressure value as well as transfers controlling commands to alter the pressure imparted on both ends of the microchannel, which would hence regulate the flowing speed and direction of the fluid and the location of the cells within the fluid. Therefore, a quick and accuracy experiment on cell culture is achieved.

The relevant device can be efficient developed as an automatic equipment for devoting itself to the dynamic cell studies and experiments, which hence has wide applications on the science research and the medical detection or studies.

The advantages of the present invention over the known prior arts will become more apparent to those of ordinary skilled in the art by reading the following descriptions with the relating drawings.

### BRIEF DESCRIPTION OF THE DRAWINGS

FIG. 1a is a schematic view showing the chip of the present invention;

FIG. 1b is a partial schematic view showing the upper portion of the chip of the present invention;

FIG. 1c is a partial schematic view showing the lower portion of the chip of the present invention;

FIG. 1d is a schematic view showing the cell collecting unit within the chip of the present invention;

FIG. 1e is a schematic view showing the microchannel within the chip of the present invention;

FIG. 1f is a schematic view showing the cell control unit within the chip of the present invention;

FIG. 1g is a schematic view showing another cell control unit within the chip of the present invention;

FIG. 1h is a schematic view showing the micro pit within the chip of the present invention;

FIGS. 2a-2g are schematic views showing the particle traveling through the microchannel of the chip under the microscope;

FIG. 3 is a schematic view showing the application of the pit array on indicating the fluid channel;

FIGS. 4a-4c are schematic views showing the procedures of controlling the grown cells within the chip;

FIG. 5 is a schematic view showing the damping fluid channel with manifold structure in the microchannel of the chip;

FIG. 6 is a schematic view showing the arrangement of the exterior magnetic field round the chip;

FIG. 7 is a schematic view showing the increment of the acoustic wave generator within the chip;

FIG. 8 is a flow diagram showing the configuration of the present invention;

FIG. 9 is a schematic view showing the micro pressure device of a first embodiment;

FIGS. 10a-10c are schematic views showing the procedures of attaining the feedback of pictures;

FIG. 11 is a schematic view showing the micro pressure device of a second preferred embodiment in which cutoff valves are in serial connection to attain the pressure controlling;

FIG. 12a is a schematic view showing the micro pressure device of a second preferred embodiment in which a single fan serves as the air source;

FIG. 12b is a schematic view showing the micro pressure device of a second preferred embodiment in which multiple fans are in serial connection;

FIG. 13 is a schematic view showing the micro pressure device of a second preferred embodiment applies to fix the serial pressure value to await the shift;

FIG. 14 is a schematic view showing the micro pressure device of a third preferred embodiment in which cutoff valves are in parallel connection;

FIG. 15 is a schematic view showing the micro pressure device of a fourth preferred embodiment exerts the conjoint of the air and liquid to attain the regulation;

FIG. 16 is schematic view showing the dual microscope possessing the feature of gathering a coaxial and single light source; and

FIG. 17 is a flow diagram showing the method of the present invention.

### DETAILED DESCRIPTION OF THE PREFERRED EMBODIMENTS

Before describing in greater detail, it should note that the like elements are denoted by the similar reference numerals throughout the disclosure.

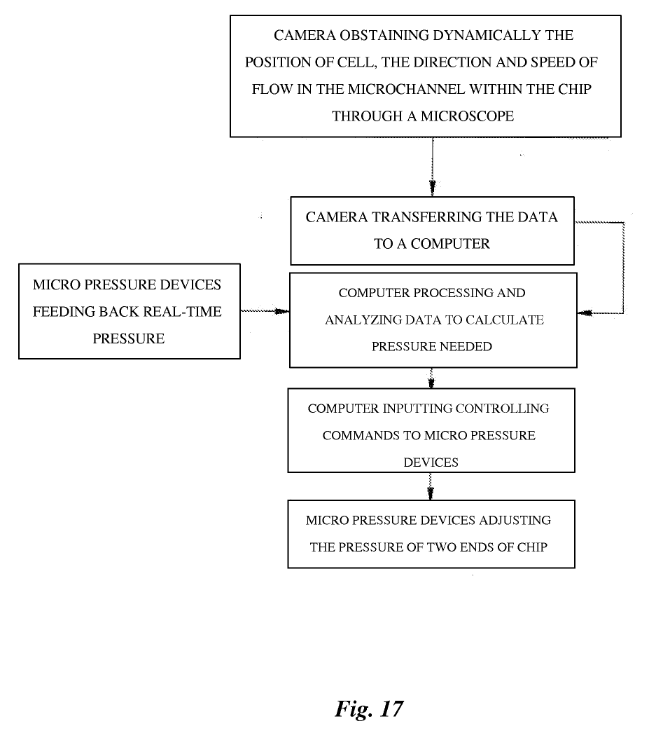

The method of the present invention for observing cells mainly combines the PCT patent application published no. WO/2006/007701 that was issued by the same applicant and disclosed the application of the microfluidic chip technology to carry out the selection, separation, retention, and the culture of the particle (i.e. single yeast cell) within the fluid channel of the chip, so as to incessantly observe and record biological parameter of the single cell while delivering and shifting the reagents. Referring to FIG. 17 shows the procedures: (1) data attaining: a camera is arranged to dynamically capture the position, the flowing orientation and speed of cells in the microchannel within the chip on a stage through a microscope and transferring the received data to a computer; (2) analyzing and comparing: the computer collects real-time data from the camera and proceeds to analyze and calculate the relation between the position of cell and pressure complied with the demand of the assay, as well as to compare the result with the real-time pressure fed back from micro pressure devices to the computer, whereby the computer accordingly serves to input controlling commands to micro pressure devices; and (3) controlling and adjusting: according to afore commands, the micro pressure devices changes the pressure subjecting to both ends of the microchannel in the chip to adjust the direction and speed of flow in the microchannels of chip so as to regulate the position of cell in the fluid.

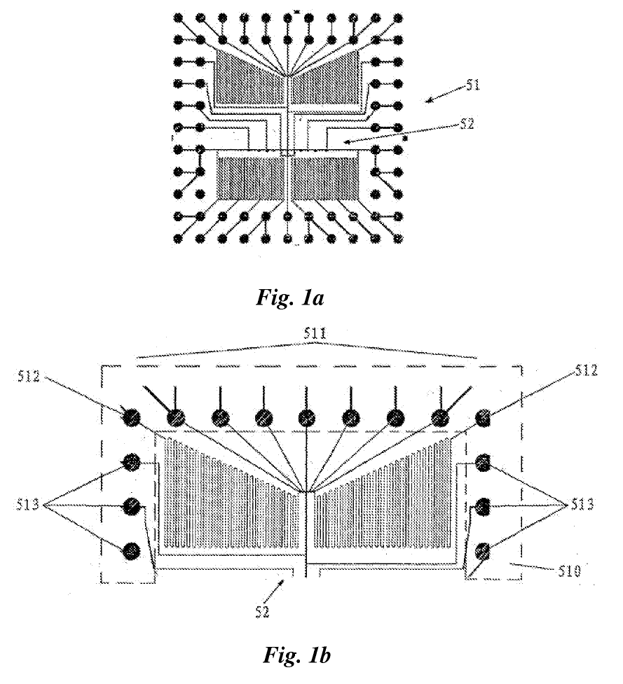

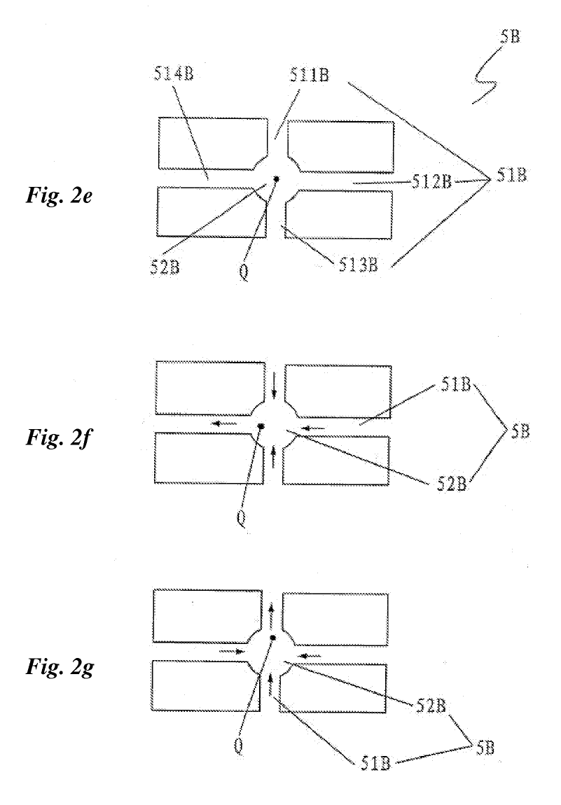

The aforementioned chip adapted for the method as shown in FIG. 1a mainly comprises a microchannel 52 (for tens or hundreds micrometers of width), an interface system 51 for the chip to communicate with the outside, and a sealing 502 (see FIG. 6). Wherein, the interface system 51 is divided into an input 511 of reagents or nutrient agar and a controlling interface 515; the microchannel 52 communicates with the interface system 51 and distributes cell control units 521 therein for making the observation and cell culture; further, the sealing 502 covers the chip to render the microchannel 52 performed in a closed status, thereby permitting the controlling interface 515 to connect with micro pressure devices and further to regulate the pressure within the microchannel 52. Both the microchannel 52 and the cell control unit 521 have respective micropits 522 where microballs can place to conduct the flowing speed and direction of the fluid at specific fluidic port, thereby performing the visualizing control of the fluid channel. The micropits 522 can be also arranged merely within the cell control unit 521.

The present invention comprises the following principles:

1. Introducing and indicating flowing speed and direction of the flow according to the location of the particle:

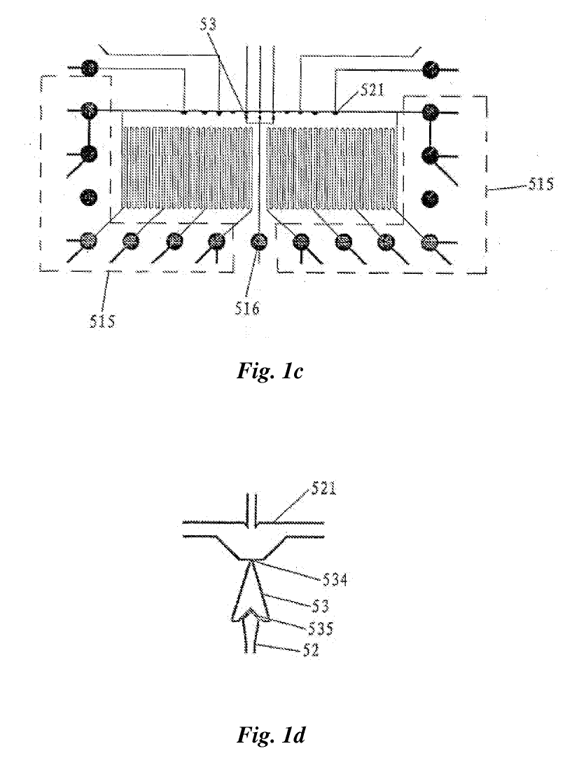

Referring to FIG. 2a-2d, if a spherical member, for instance of a ball Q sinking in the fluid, locates at the arc pit 52A in the microchannel 51A, it would be lead toward different orientations base on the flowing speed and direction of the fluid within the microchannel 51A. For example, as shown in FIG. 2a, the ball Q (illustrated by a black point) would stay at the lowest part of the pit 52A detected by a microscope while there is no fluid within the channel 51A. FIG. 2b depicts that the ball Q would be pushed forward to the left part and retained balance at the left slope when the fluid flows from the right to the left in the microchannel 51A as arrowed. FIG. 2c describes that the ball Q would be pushed forward to the right part and retained balance at the right slope when the fluid flows from the left to the right in the microchannel 51A as arrowed. FIG. 2d shows the increment of the flowing speed would result of the departure of the ball Q far from the lowest part and render a prolonged distance between the real location thereof and the lowest part. Such distance would be detected in turn to reckon the exerted flowing speed.

Referring to FIG. 2e-2g shows the microchannel 51B of the chip 5B in a 2-dimensioned structure contributed by four microchannels 511B, 512B, 513B, 514B intersecting at the pit 52B to accommodate the ball Q that serves to conduct the flowing situation of each channel. For example, FIG. 2e shows that the ball Q stays in the central when no fluid passes through the channels. Under the condition of the left channel 514B being as an output of flow, FIG. 2f shows that the ball Q shifts to the left part, and the deviating distance from the center would depend on the flowing speed. If the top channel 511B is as an output of flow, FIG. 2g shows that the ball Q shifts up (but still floats on the water level), and the deviating distance from the center would depend on the flowing speed.

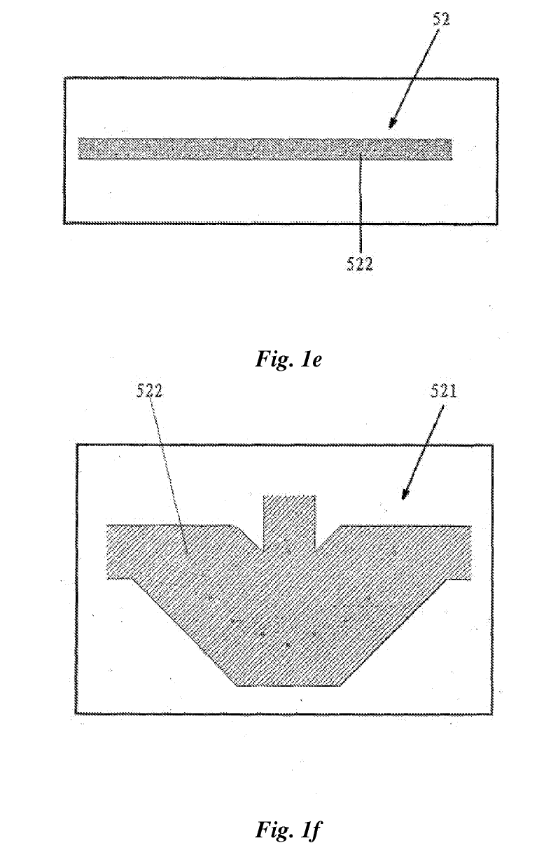

Referring to FIG. 3, the application of the pits 522 on indicating the flowing speed is not restricted and may be arranged to directly present a complex dynamical fluid field. When placing the microballs 57 inside a pit array within a fluid channel, each fluidic port showing of the speed and direction of the fluid would be performed by the balls 57, so as to calculate the fluid field at the specific moment.

Regulating the position of the cells by controlling the pressure exerted on two ends of the microchannel:

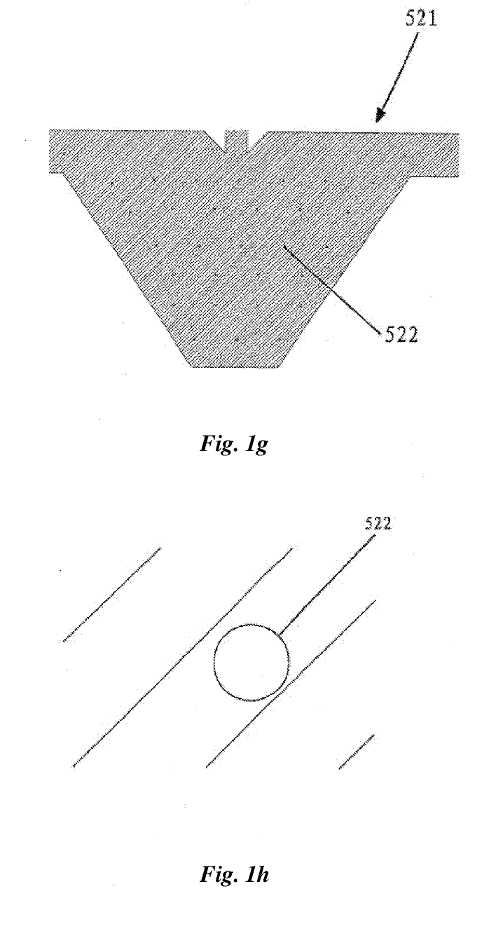

Referring to FIG. 4a-4c show a cell control unit 6; wherein, the fluid enters from a passage 63. If the cell is in balance as illustrated in FIG. 4a, the pressure exertion on both ends 61, 62 would be maintained. The cell herein can be as a spherical and heavy ball or in other appropriate performances. Further, if users try to shift it toward the right as shown in FIG. 4b, the pressure imparted to the left end 61 would be increased; in like manner, FIG. 4c shows the increased pressure exerted to the right end 62 to render the cell moved to the left. Therefore, the cell would be stationarily set at the desired position beneficial for the observation, thereby ensuring working capability on the nutrition absorption and the metabolism of the cell to smoothly carry out the cell culture under the changeable environment of fluid.

A liquid damping device, for instance of a fluid channel with manifold structure, serves to buffer the liquid; wherein, the damping device disposed in the controlling flow assists to reduce the sensitivity of liquid to the pressure variation and to enhance the precision of the pressure to the flow speed adjustment.

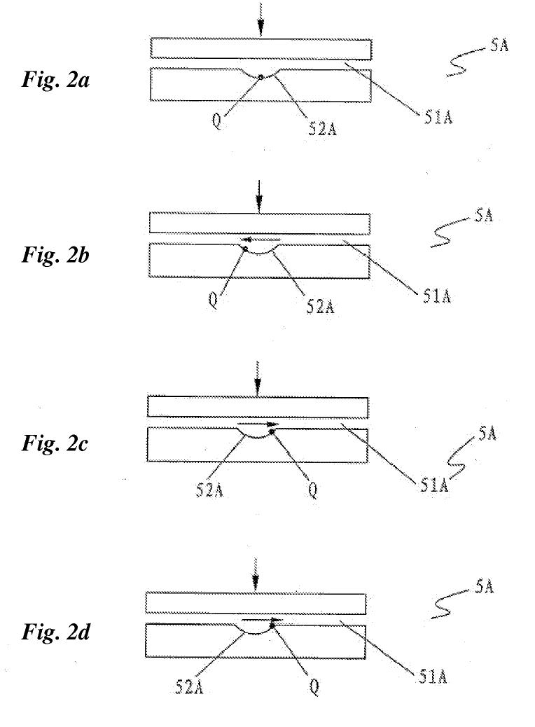

Referring to FIG. 5, the fluid enters from the point C and travels out of the points A and B, so the way to control the cell is to regulate the pressure to points A and B. With respect to the same pressure variation, the increment of the manifold fluid channel of the damping device would facilitate to decrease the fluctuation of the flowing speed, so as to modulate the sensitivity of the flowing speed to the pressure and precisely control the supplement of the pressure.

A preferred embodiment of the present invention as shown in FIG. 1a mainly comprises an integrity chip made of glass, whose dimension is preferably at 63 mm*63 mm. The chip further has an interface system 51 that contains 72 interfaces each with 2 mm diameter distributing around the chip. The interface serves as a pin of CPU for communicating the fluidic chip with the outside. Additionally, the transparent sealing is mainly made of Polydimethylsiloxane (PDMS) covers the entire chip to obturate the microchannel 52 of the chip, so as to adjust the pressure within the microchannel. The interface system 52 is further divided into an input of reagents or nutrient agar and a controlling interface 515 as set forth below.

FIG. 1b depicts the input arranges an entrance 511 adapted for common liquid that requires damping buffering and also provides a distinctive entrance 513 adapted for specific liquid that is merely applied to the reagents with small and fixed measurement. To discharge the redundant liquid before injecting the fluid into the channel of cell culture, the chip has an exit 512 disposed thereon and arranges a set of damping channel interposed between the entrance 511 and the exit 512 for acting as a buffer to eject the redundant liquid.

FIG. 1c shows the controlling interface 515 applied to sampling, growing, controlling, and collecting cells. The controlling interface 515 connects to two ends of the cell control unit through the damping microchannel and engages to different positions within damping the microchannel in order to adapt kinds of cells relative to kinds of damping coefficients. Practically, the controlling interface 515 is not only used as a bridge to connect an exterior micro pressure device but as a medium for entries of the cell and the liquid. Moreover, the microchannel of the chip contains cell control units 521 proceeding to grow and observe the cell, in the middle of which three units 521 have their inner walls attached to a cell collecting unit 53 (shown in FIG. 1d) that serves to collect and save the cells. Wherein, the cell collecting unit is formed of a gradual wider configuration, of which the narrow portion has one edge joined to the cell control unit 521; a blocking wall 534 is disposed at the joint for interfering the motion of the cells at a certain flowing speed. Further, the wider portion has one edge thereof attached to the interface system 515 through the microchannel 52 and also has a blocking wall 535 serving to obstruct the cell flow; the wider portion can also guide the cultured cell within the cell collecting unit 53 out through the interface. Referring to FIG. 1d shows the traveling of the fluid from the cell control unit 521 to the cell collecting unit 53. When the fluid passes through the blocking wall 534 of the narrow portion by a greater flowing velocity, the cell would accompany the fluid to the cell collecting unit 53. Further, the blocking wall 535 with the wider portion conduces to decrease the flowing speed so as to efficiently separate the cell from the fluid and retain the cell within the cell collecting unit 53. The wider portion of the cell collecting unit 53 further connects with a cell container 516 (shown in FIG. 1c) for accommodating the cell, from which users can derive it depend on demands.

The microchannel 52 and the cell control unit 521 arrange a set of pits 522 to become a pit array (shown from FIG. 1e to 1g). The microballs in the pits would depict the flowing speed and directions of the fluid distributed among the fluidic ports. The pit array would directly show the fluid channel at the specific moment, and the real-time result would assist the controlling system to have an accurate execution. For example, FIGS. 1g and 1f depict that the pit array 522 within the cell controlling unit 521 can perform by various formations, and the arrangement of the pit array at each intersection of the microchannel 52 further proceeds to present the flowing quantity of different fluid channels, thereby efficiently controlling the injection of the reagents in a regular measurement for benefiting the cell culture.

The microballs placed within the pit 522 are magnetic balls. The balls are subjected to slightly vibrate under the stimuli of an exterior magnetic field, thereby avoiding the adhesions of the balls on inner walls of the pits to affect the conduction and indication. Namely, by regulating the strength of the magnetic field in the fixed orientation, a force applied to the magnetic balls would be changed to adjust the sensitivity thereof. For example, referring to FIG. 6 shows the configurations of the glass 501 of the chip 5 overlapped with the sealing 502 and a coil 7 disposed below the chip 5. A current at the intersection of direct current and alternating current is delivered to the coil 7 to create a suitable intensity and magnetic field adapted for controlling the power toward the magnetic ball in the chip, hence retaining the ball within the pit and steadily driving the sensitivity of the ball to the flowing speed and direction of the fluid.

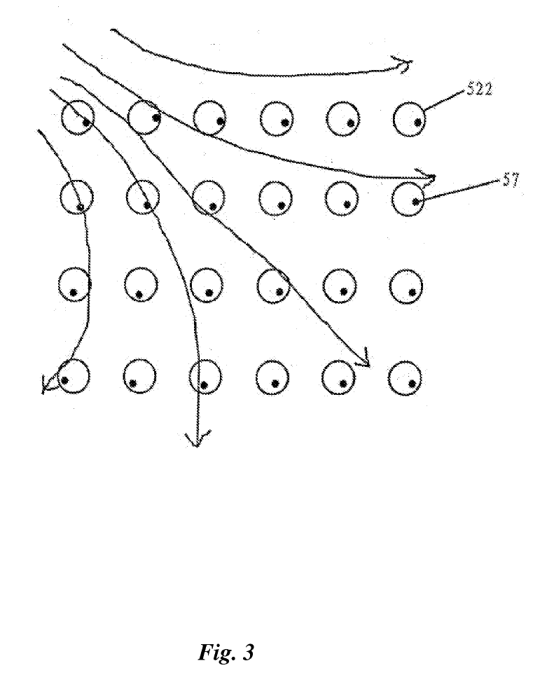

Essentially, the adhesion of the cells inside the microchannel affects the experiment controlling, and the adhesion would be subjected to acoustic wave. Therefore, an acoustic wave generator 8 as illustrated in FIG. 7 can be embedded into the chip 5 to eliminate the occurrence of adhesion.

From the above, the present invention has following advantages:
1. By means of the arrangements of pits within the microchannel and the cell control unit for receiving microballs, the flowing speed and direction of the fluidic port would be conducted by the pits or pit array at the specific moment to generate a result. Thus, the real-time result would assist the controlling system to have an accurate execution, so as to perform the visualizing control of the fluid channel
2. The integrity chip accompanying with the configuration of the interface system that includes an input of reagents or nutrient agar and a controlling interface as well as the cell controlling unit of the microchannel assists the chip to be widely applied for technique fields.
3. The fluid damping device disposed in the controlling flow assists to reduce the sensitivity of liquid to the pressure variation and to enhance the precision of the pressure to the flow speed adjustment.
4. The chip also has the damping microchannel attached to the input of reagents or nutrient agar for achieving the effect of buffering liquid.
5. The cell controlling unit not only renders the cell to be stationarily retained therein beneficial for the observation but efficiently exerts the cell culture under the dynamic fluidic environment.
6. The microchannel within the chip comprises a plurality of doors communicated with the outside, so as to eliminate the air inside the channel and fill the channel with liquid.
7. The microchannel within the chip comprises a plurality of doors for the alternate utilization, thereby maintaining the operation of the experiment.
8. The microballs are magnetic balls. The balls are subjected to slightly vibrate under the stimuli of an exterior magnetic field, thereby avoiding the adhesions of the balls on inner walls of the pits to affect the conduction.
9. The embedment of the acoustic wave generator into the chip serves to eliminate the occurrence of adhesion.

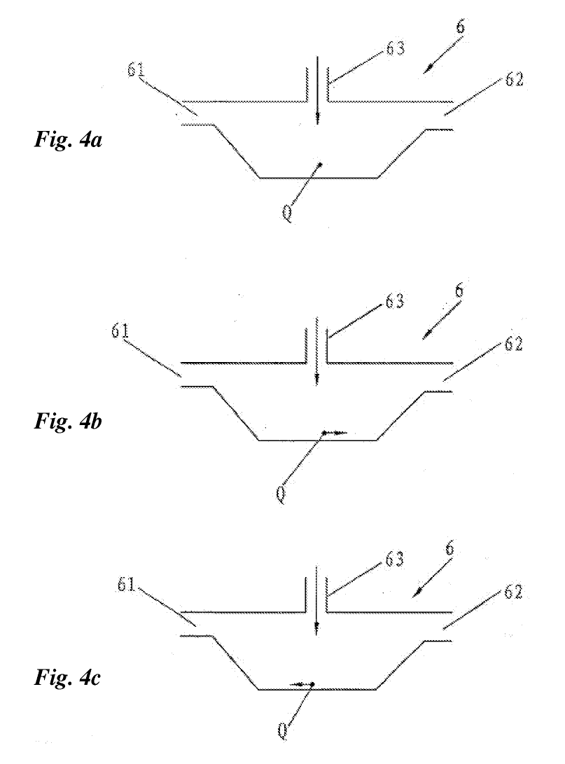

Referring to FIG. 8, the device of the present invention for observing cells mainly comprises a microscope 1, a camera 2, a computer 3, micro pressure devices 4, and a chip 5; wherein, the chip 5 is as aforementioned formed of an integrity chip; the computer 3 connects with a USB of the camera 2 through system address buses; the camera 2 is attached to the microscope 1; the chip 5 is put on a stage between an eyepiece 31 and an object glass, so that the eyepiece 31 could aim at the cell control unit 521 of the chip 5; the micro pressure devices 4 are joined to the controlling interface 515 of the chip 5 by pneumatic lines for regulating the pressure within the microchannel 52.

The present invention can further increase some auxiliary equipments, such as a temperature controlling device, an oxygen pressure division controlling device, an automatic injecting device, a grown cell gathering device, an automatic reagents shifter, an auto reagents mixing apparatus, fluorescent signal measuring device, an auto chip cleaning apparatus, and etc.

The device of the present invention includes following principles:

The microscope 1 is adopted by an inverting microscope, of which the object glass would be arranged under the chip 5. The chip 5 would thence connect with the micro pressure devices 4. Further, the camera 2 belongs to a digital inspecting apparatus for receiving both dynamic and static signals and accordingly delivers the received data to the computer 3 for the analysis. The camera 2 also possesses the characteristic of recording the process of the experiment and culture. The micro pressure devices 4 connect to the computer 3 by data lines, and the computers includes a software adapted for analyzing the position and shifting speed of the target cell or particle and further compares the analyzed result with the real-time pressure fed back from the micro pressure devices 4 to the computer 3, whereby the computer 3 accordingly serves to input proper controlling commands to the micro pressure devices 4. Thence, the micro pressure devices 4 would change the pressure subjecting to both ends of the microchannel in the chip according to afore commands sent from the computer software to adjust the flowing direction and speed of fluid in the microchannels of chip 5 so as to regulate the position of cell in the fluid.

The micro pressure device herein can adopt controlling ways regulated by air pressure and hydraulic pressure.

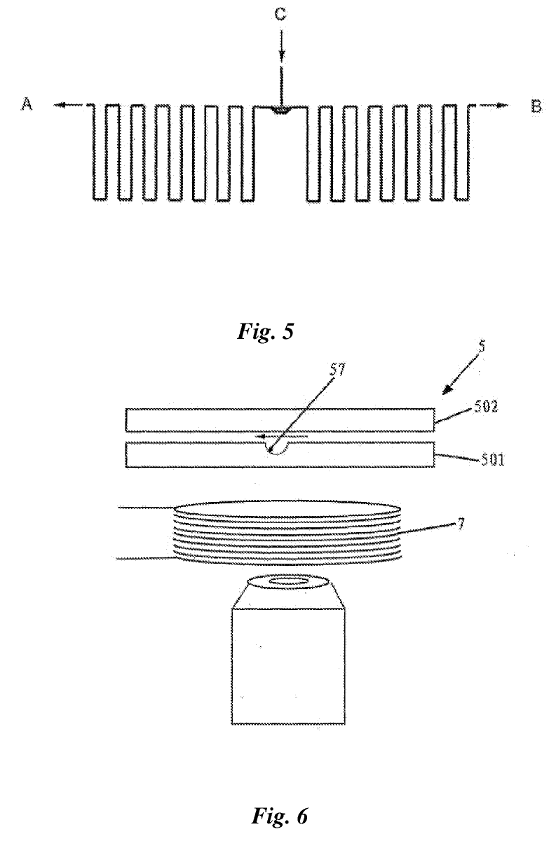

Referring to FIG. 9, the micro pressure devices 4 of a first preferred embodiment comprises a pressure source 41 and multiple air pressure controlling units 42, and herein merely three units 42A, 42B, 42C are illustrated; the pressure source 41 connects with the air pressure controlling units 42 by an air pressure passage 43.

Still further, the pressure source 41 mainly consists of a vacuum pump 411, a vacuum pond 412, a pressure exchanger 413, and a gauging apparatus 414; wherein, the vacuum pump 411 connects with the vacuum pond 412, the gauging apparatus 414 electrically engages with the vacuum pump 411 and attaches to the vacuum pond 412 through the pressure exchanger 413.

The air pressure controlling unit 42 includes a flow adjusting valve 421, an electromagnetic valve 422, a buffering container 423, a pressure exchanger 424, and a gauging mean 425; wherein, there are two sets of the flow adjusting valves 421 in serial connection with the electromagnetic valves 422, and the two sets thereof are respectively engaged with an input passage and an output passage of the buffering container 423. The sequential correlation of the interrelated elements engaged to the input passage is: the electromagnetic valve 422, the flow adjusting valve 421, and the buffering container 423; in addition, the sequential correlation of the interrelated elements engaged to the output passage is: the flow adjusting valve 421, the electromagnetic valve 422, and the buffering container 423. The gauging mean 425 electrically communicates with the electromagnetic valve 422 disposed on the input and output passages of the buffering container 423 and are joint to the buffering container 423 through the pressure exchanger 424.

With respect to the principle of the micro pressure devices 4, multiple air pressure controls 42 of the micro pressure devices 4 would be applied to fit with demands of the channel of the chip 5. Each channel thereof is controlled relative to the each air pressure control 42 of the micro pressure devices 4 (shown of one in FIG. 9). The air pressure of the vacuum pond 412 transfers the information of air pressure from the pressure exchanger 413 to the gauging apparatus 414. The gauging apparatus 414 accordingly institutes the data base on the information and outputs controlling currents to turn on or off the vacuum pump 411 (or a compressing apparatus), so as to control and balance the air pressure within the vacuum pond 412. The pressure of the vacuum pond 412 is merely deemed as the pressure source but is not directly transferred to the chip 5. The buffering container 423 is the critical element attached to the chip 5 for determining the air pressure imparted to the chip 5. The buffering container 423 has one end thereof connected with the vacuum pond 412 to attain the real pressure similar to that of the vacuum pond 412 and the other end thereof communicated with the outside to attain the pressure similar to the atmospheric pressure. As a result, the pressure within the buffering container 423 would be strictly restricted amidst the atmospheric pressure and the pressure of the vacuum pond 412, and the speed of the pressure variation would also be accurately regulated by the flow adjusting valve 421, so as to well control the pressure intensity and the velocity exerted on the chip 5. Additionally, the impulsion attendant with the pressure regulation would be relatively declined gradient to the desired value under the buffer incurred by the buffering container 423. That is, the gauging mean 425 proceeds to compare the pressure information from the pressure exchanger 424 with a predetermined threshold and transfers the results to control the electromagnetic valve 422, hence to regulate the pressure within the buffering container 423. Wherein, each gauging mean 425 connects to RS 485 control buses and provides the threshold through the system address buses of the computer 3. Concurrently, the pressure information detected by the gauging mean 425 is transferred to the computer 3 through the address buses as well. In like manner, hundreds of air pressure controlling units can be processed on RS 485 buses.

In practical, each micro pressure device of the present invention may tend to apply a static pressure controlling, that is, the air keeps quiescent within the container without floating when no pressure regulation persists. Such static state would be liable to temperature, pressure, and efflux of the gas. Oppositely, a dynamic control mainly renders an incessant flowing of the air, in which the air would gradually be changed under the motivation of the pressure incurred by resistances or frictions while the air is flowed from the higher voltage to the lower voltage.

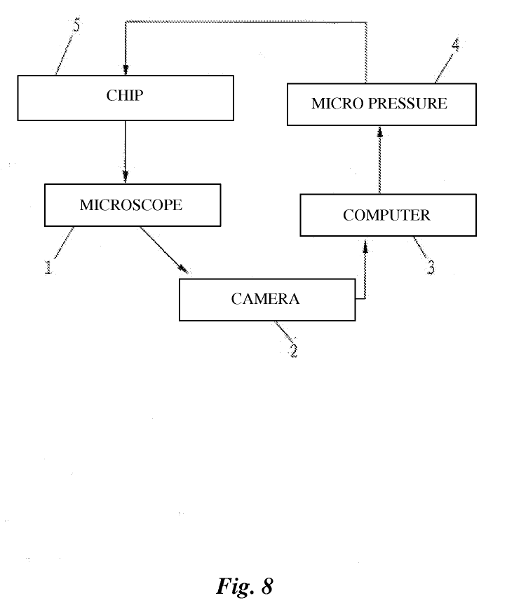

the micro pressure devices of a second preferred embodiment applies the aforementioned dynamic control to gradually change the air under the motivation of the pressure incurred by resistances or frictions while flowing it from the higher voltage to the lower voltage. If the pressure device serially connects with the cutoff valves, the pressure of each section would be efficiently controlled, namely the sectional pressure passes through the valves would be stable as long as the pressure differences on the beginning and the end portions remains balance. For example, FIG. 11 depicts that the gas floats or transits from P0 to P1 by the serial of cutoff valves V1, V2, V3, V4 proceeding to control the pressure intensity P2, P3, P4, so that the air pressure from P0 to P1 would be distributed to P2, P3, P4 for satisfying the requirements. If the flowing quantity of V3 decreases, the pressure of P4 would be decreased toward the orientation of P1 and those of P2, P3 would also be relevantly raised toward the orientation of P0. Therefore, the regulation of the flow adjusting valve stably facilitates the reduction of the pressure.

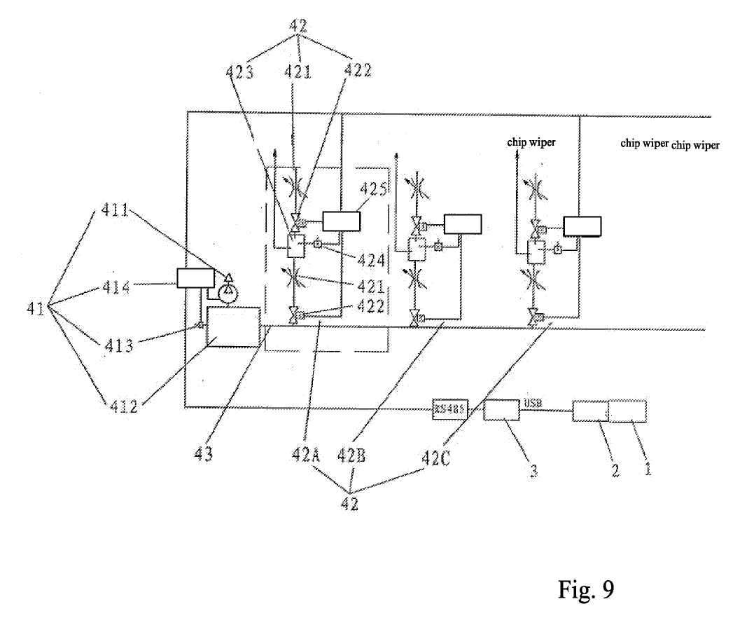

To meet the demands of supplying large amounts of the air pressure source, the vacuum pump serving to generate the air pressure can be substituted by proper devices with greater quantities, such as a fan. Each fan can be in serial connection to raise the pressure difference and the adjustment on the rotation speed thereof can promote to adjust the air pressure. Further, the pressure difference would also depend on the power capability, rotation speed, and numbers of the fan. For example, FIG. 12a, 12b depicts that the more fans are serially connected, the greater pressure difference is attained, namely the pressure difference between P2 (FIG. 12b) and the air is greater than the pressure difference between P1 (FIG. 12a) and the air.

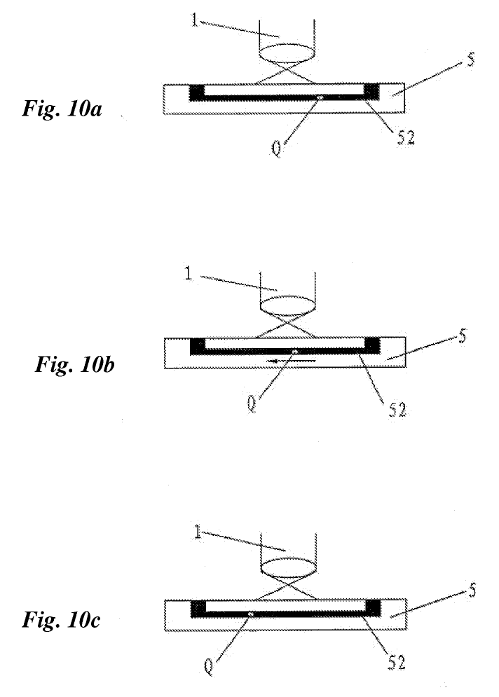

Besides the application on pressure regulation to fit with the characteristic of such serial connection, the present invention can also apply a rapid reaction that fixes the serial pressure value to await the shift. As shown in FIG. 13, the adjustment of the pressure substantially depends on the position of the cell. For example, when the cell is at the position A, the P10 would thence be adopted; similarly, when the cell is respectively located at the position B, C, D, and E, the P20, P30, P40, and P50 would thence be respectively adopted as well. Herein the P10, P20, and P30 are relative to the pressure output from P2, P3, and P4 (shown in FIG. 11).

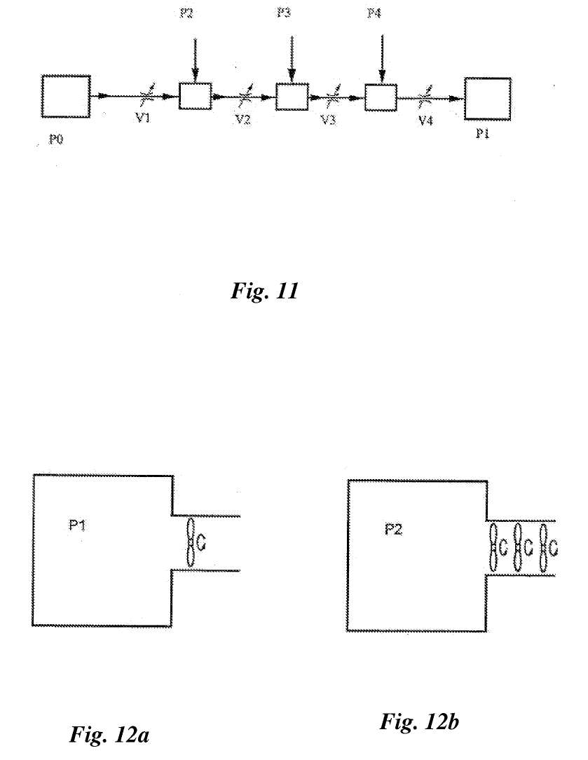

However, the difficulty attendant on such serial connection is that the sectional pressure on the entire channel would be changed while regulating any one of the cutoff valves. The micro pressure device of a third preferred embodiment can thence arrange the cutoff valves into parallel connections for discretely controlling the sectional pressure. For example, FIG. 14 shows that the valves V1 and V2 serve to regulate the P2, the valves V3 and V4 serve to regulate the P3, and the V5 and V6 valves serve to regulate the P4. The pressure source of this preferred embodiment can also be in serial connection.

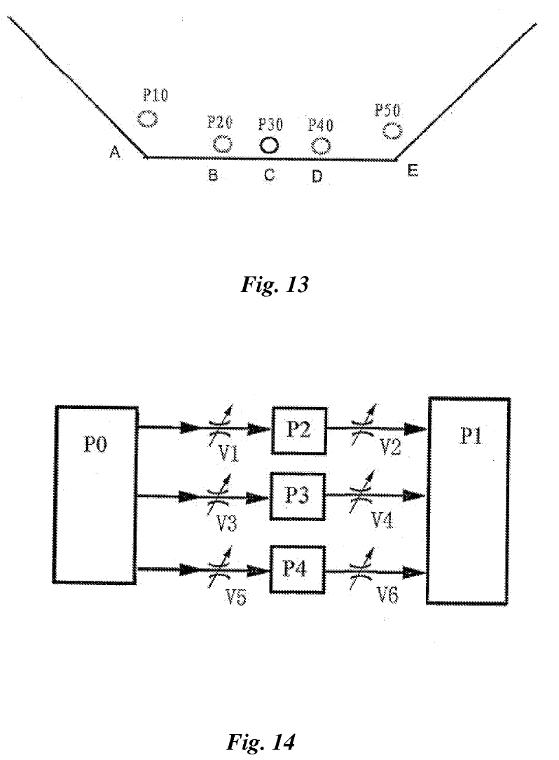

The micro pressure device of a fourth preferred embodiment mainly proceeds to control hydraulic pressure by a displacing detector. The hydraulic pressure regulation has an adjustment more precise than that of the air pressure regulation but essentially has lower modulating ranges. Accordingly, it adopts to use the air pressure control accompanying the hydraulic pressure adjustment to attain the purpose of pressure controlling. Due to the possession of rapid reaction, the air pressure control serves to control the cells back to an anticipated location; further, the liquid adjustment takes advantages of executing the precise regulation to obviate the unbalance of the long-term cell culture, for instance the loss balance of the liquid level or of the damping. The air pressure control and the liquid height adjustment can be a system embedded into the computer so as to attain an automatic controlling effect. The liquid height is an incessant adjustment on the hydraulic pressure so as to continuously control the position of the cell within a certain the range adjacent to the center of the working place. If a further range far from the center is required, an air pressure controlling is thence needed. Referring to FIG. 15, the height of the liquid can be controlled by the computer and the online data information can be achieved by the displacing detector, whereby, the computer would reckon the hydraulic pressure A, and simultaneously the air pressure B is output by the air pressure device. These two pressures would be incorporated into a synthetic pressure C (C=A+B) and be transferred to the chip.

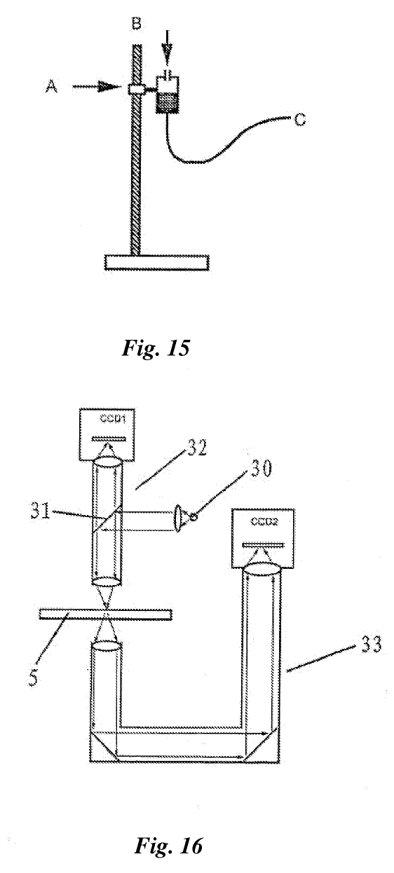

The present device can not only use the single microscope to observe the optical path but applies a dual microscope for gathers a coaxial and single light source. Referring to FIG. 16, different charge coupled devices (CCDs) essentially make observations in different magnifications under the optical microscope. The high magnification usually serves to capture pictures of cells or particles for the micro-observation, and the low magnification with large visual field capturing the instant pictures thereof often serves to control cells or particles. In this figure, when a light emitted from the light source 30 (white or colorful light) enters a reflecting microscope 32 through a reflecting mirror 31. Further the reflected light returns to a CCD1 of the reflecting microscope that serves to observe the dynamic images for satisfying the dynamic control of the chip 5; the light through the chip 5 is captured by a CCD2 of the inverting microscope 33 that serves to attain the biology observing analysis. It can also apply a fluorescent reverting microscope for analyzing fluorescent pictures.

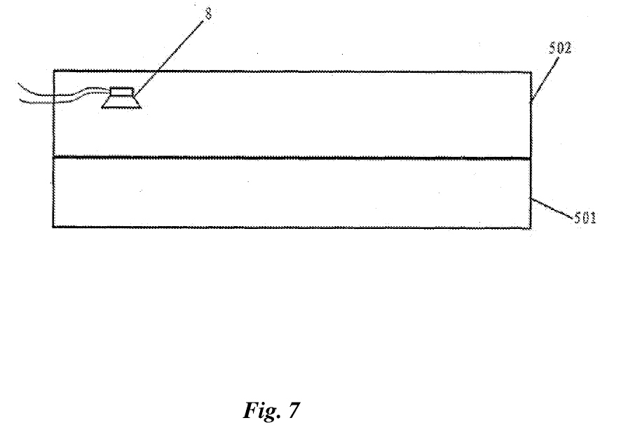

Since the microball 57 within the pit array of the microchannel 52 of the chip 5 is visualized by the microscope 3, the method of the present invention as shown from FIG. 10a to FIG. 10c mainly applies the software of the computer to determine the flowing speed and direction of the fluid according to the position of the microball 57 detected by the camera and subsequently exerts to transfer controlling commands to alter the pressure imparted on both ends of the microchannel, which would hence regulate the speed and direction of the flow and the location of the cells within the microchannel at the desired value.

FIG. 4a to 4c depicts the pressure controlling procedures of the cell within the microchannel and shows a configuration of a cell control unit 6; wherein, the fluid enters from a passage 63, and the cell retained on the arc pit would conduct the fluid field shape and intensity around the cell. Thence, the dynamic analysis facilitates to control the cell culture and experiment by utilizing the proper and instant regulating and feedback.

If the cell is in balance as illustrated in FIG. 4a, the pressure exertion on both ends 61, 62 would be maintained. The cell herein can be as a heavy ball or other appropriate shapes. Further, if users try to shift it toward the right as shown in FIG. 4b, the pressure imparted to the left end 61 would be increased; in like manner, FIG. 4c shows the increased pressure exerted to the right end 62 to render the cell shifting to the left.

To sum up, the method for observing cells in accordance with the present invention comprises procedures of: (1) data attaining: a camera 2 is arranged to dynamically capture the position, the flowing orientation and speed of cells in the microchannel within the chip 5 on a stage through a microscope 1 and transferring the received data to a computer 3; (2) analyzing and comparing: the computer 3 collects real-time data from the camera 2 and proceeds to analyze and calculate the relation between the position of cell and pressure complied with the demand of the assay, as well as to compare the result with the real-time pressure fed back from micro pressure devices to the computer, whereby the computer accordingly serves to input controlling commands to micro pressure devices; and (3) controlling and adjusting: according to afore commands, the micro pressure devices 4 change the pressure subjecting to both ends of the microchannel in the chip 5 to adjust the flowing direction and speed of fluid in the microchannels of chip 5 so as to regulate the position of cell in the fluid.

While we have shown and described the embodiment in accordance with the present invention, it should be clear to those skilled in the art that further embodiments may be made without departing from the scope of the present invention.

I claim:

1. A method for observing cells, a chip and a device comprising the procedures of:
(1) data attaining: a camera obtaining dynamical data performing positions of cells, the direction and speed of flow in a microchannel within said chip on a stage through a microscope and transferring said data to a computer;
(2) analyzing and comparing: said computer collecting said data from said camera for proceeding analysis, calculating a relation between said position of cell and pressure complied with requirements of an assay, comparing said calculated result with a real-time pressure fed back from micro pressure devices to said computer, and outputting controlling commands to said micro pressure devices; and
(3) controlling and adjusting: said micro pressure devices proceeding to change pressure imparted on two ends of microchannel in said chip according to said commands, so as to adjust flowing direction and speed of fluid in said microchannels of said chip and regulate said positions of said cells within said fluid.

2. The chip for observing cells as claimed in claim 1, wherein said chip has a microchannel, an interface system for communicating said chip with the outside, and a sealing; said interface system is divided into an input of reagents or nutrient agar and a controlling interface; said microchannel defines a curved cell control unit for proceeding observation and cell culture and has both ends thereof connected to said controlling interface, so as to attach a side hole on a side wall of said microchannel face to said opening of said cell control unit with said input of reagents or nutrient agar; said sealing covering said chip serves to obturate said channel of said chip; said cell control unit has pits where microballs can place.

3. The chip for observing cells as claimed in claim 2, wherein both said microchannel and said cell control unit have respective pits for accommodating said microballs.

4. The chip for observing cells as claimed in claim 2, wherein said cell control unit arranges a set of said pits to become a pit array.

5. The chip for observing cells as claimed in claim 2, wherein said input of reagents or nutrient agar can be divided into an input adapted for common liquid that requires damping buffering and an input adapted for specific liquid that is merely applied to reagents with small and fixed measurement.

6. The chip for observing cells as claimed in claim 2, wherein said controlling interface connects to two ends of said cell control unit through a damping microchannel.

7. The chip for observing cells as claimed in claim 2, wherein said controlling interface connects to two ends of said cell control unit through a damping microchannel, and said controlling interface attaches to different positions within said damping microchannel.

8. The chip for observing cells as claimed in claim 2, wherein said chip is an integrity chip; said interface system includes an input of reagents or nutrient agar and a controlling interface; said microchannel has a cell control unit arranged thereon; said input of reagents or nutrient agar can be divided into an input adapted for common liquid that requires damping buffering and an input adapted for specific liquid that is merely applied to reagents with small and fixed measurement; said controlling interface connects to two ends of said cell control unit through said microchannel, and said controlling interface attaches with different positions within a damping microchannel.

9. The chip for observing cells as claimed in claim 2, wherein said microballs are magnetic balls.

10. The chip for observing cells as claimed in claim 2, wherein said cell control unit has an inner wall attached to a cell collecting unit; said cell collecting unit is formed of a gradual wider configuration, of which a narrow portion has one edge joined to said cell control unit, so that a blocking wall is disposed at said joint, and of which a wider portion has one edge connected to said interface system through said microchannel, so that a further blocking wall is disposed at said connection.

11. The device for observing cells as claimed in claim 1, wherein said device has a microscope, a camera, a computer, micro pressure devices, and a chip; wherein, said computer connects with said camera through system address buses; said camera is attached to said microscope; said chip is put on a stage; said micro pressure devices have respective pressure outputs joined to said controlling interface of said chip by lines;
said pressure outputs connect to said computer by data lines so as to render mutual feedbacks of pressure and accept said controlling commands from said computer.

12. The device for observing cells as claimed in claim 11, wherein each of said micro pressure device is comprised of a pressure source and multiple air pressure controlling units; said pressure source connects with said air pressure controlling units through an air pressure passage; said pressure source mainly consists of a vacuum pump, a vacuum pond, a pressure exchanger, and a gauging apparatus; wherein, said vacuum pump connects with said vacuum pond, said gauging apparatus electrically engages with said vacuum pump and attaches to said vacuum pond through said pressure exchanger; said air pressure controlling unit includes a flow adjusting valve, an electromagnetic valve, a buffering container, a pressure exchanger, and a gauging apparatus; two sets of means assemblies are formed by serially connecting said flow adjusting valves with said electromagnetic valves, and said two sets thereof are respectively engaged with an input passage and an output passage of said buffering container; said gauging apparatus is electrically connected with said electromagnetic valves disposed on said input and output passages of said buffering container and is joint to said buffering container through said pressure exchanger.

13. The device for observing cells as claimed in claim 11, wherein said micro pressure device applies said pressure source to serially connect with a series of cutoff valves.

14. The device for observing cells as claimed in claim 11, wherein a plurality of fans in serial connection can be served to substitute said pressure source.

15. The device for observing cells as claimed in claim 11, wherein said micro pressure device applies said pressure source to be in parallel connection with a series of cutoff valves.

16. The device for observing cells as claimed in claim 11, wherein said micro pressure device adopts a rapid reaction that fixes a serial pressure value to await shifting.

17. The device for observing cells as claimed in claim 11, wherein said micro pressure device proceeds a hydraulic pressure controlling by a displacing detector.

18. The device for observing cells as claimed in claim 11, wherein said micro pressure device proceeds controlling pressure by incorporating regulations of controlling air pressure and regulating hydraulic pressure.

19. The device for observing cells as claimed in claim 11, wherein said microscope belongs to a dual microscope having an optical path that gathers a coaxial and single light source; said dual microscope further comprises a reflecting microscope and an inverting microscope; a light from said light source is thrown to said chip by entering into an optical axis of said reflecting microscope through a reflecting mirror; said reflected light returns to a CCD1 of said reflecting microscope that serves to satisfy a dynamic controlling of said chip; said light through said chip is captured by a CCD2 of said inverting microscope that serves for a biology observing analysis.
